(19) United States
(12) Patent Application Publication
(10) Pub. No.: US 2004/0155794 A1
(43) Pub. Date: Aug. 12, 2004

(54) Downhole telemetry system using discrete multi-tone modulation with adaptive noise cancellation

(75) Inventor: Wallace R. Gardner, Houston, TX (US)

Correspondence Address: CONLEY ROSE, P.C., P. O. BOX 3267, HOUSTON, TX, 77253-3267, US

(73) Assignee: Halliburton Energy Services, Inc., Houston, TX

(21) Appl. No.: 10/359,930

(22) Filed: Feb. 6, 2003

(51) Int. Cl. G01V 3/00

(52) U.S. Cl. 340/855.7

(57) ABSTRACT

A method and a downhole telemetry system using discrete multitone modulation and adaptive filtering. The downhole telemetry system includes a downhole transmitter, a cable, and a surface receiver coupled to the downhole transmitter via the cable. The surface receiver adaptively filters noise from a signal received from the downhole transmitter. The method includes receiving a time-domain signal carrying desired information at specific frequencies and adaptively filtering at least a portion of the noise from the time-domain signal. The time-domain signal includes noise. The method may also include delaying the time-domain signal by a delay time to form a delayed time-domain signal, and adaptively filtering at least a portion of the periodic noise from the time-domain signal using the delayed time-domain signal. The method may also include receiving a reference signal from each of one or more sensors located to receive an indication of a component of the noise, and adaptively filtering at least a portion of each component of the noise from the time-domain signal using at least the reference signal from one of the one or more sensors.

### BACKGROUND

1. Field of the Invention

The present invention relates generally to high speed digital data communications. More specifically, the invention relates to a high-speed communications scheme for transferring telemetry data between downhole sensors and a surface installation using discrete multi-tone modulation while removing noise from the telemetry data signal using adaptive filtering.

2. Description of Related Art

Modern petroleum drilling and production operations demand a great quantity of information relating to parameters and conditions downhole. Such information typically includes characteristics of the earth formations traversed by the wellbore, along with data relating to the size and configuration of the borehole itself. The collection of information relating to conditions downhole, which commonly is referred to as “logging”, can be performed by several methods.

In conventional oil well wireline logging, a probe or “sonde” housing formation sensors is lowered into the borehole after some or all of the well has been drilled, and is used to determine certain characteristics of the formations traversed by the borehole. The upper end of the sonde is attached to a conductive wireline that suspends the sonde in the borehole. Power is transmitted to the sensors and instrumentation in the sonde through the conductive wireline. Similarly, the instrumentation in the sonde communicates information to the surface by electrical signals transmitted through the wireline.

An alternative method of logging is the collection of data during the drilling process. Collecting and processing data during the drilling process eliminates the necessity of removing or tripping the drilling assembly to insert a wireline logging tool. It consequently allows the driller to make accurate modifications or corrections as needed to optimize performance while minimizing down time. Designs for measuring conditions downhole including the movement and location of the drilling assembly contemporaneously with the drilling of the well have come to be known as “measurement-while-drilling” techniques, or “MWD”. Similar techniques, concentrating more on the measurement of formation parameters, commonly have been referred to as “logging while drilling” techniques, or “LWD”. While distinctions between MWD and LWD may exist, the terms MWD and LWD often are used interchangeably. For the purposes of this disclosure, the term MWD will be used with the understanding that this term encompasses both the collection of formation parameters and the collection of information relating to the movement and position of the drilling assembly.

Sensors or transducers typically are located at the lower end of the drill string in MWD systems. While drilling is in progress these sensors continuously or intermittently monitor predetermined drilling parameters and formation data and transmit the information to a surface detector by some form of telemetry. Typically, the downhole sensors employed in MWD applications are positioned in a cylindrical drill collar that is positioned close to the drill bit. The MWD system then employs a system of telemetry in which the data acquired by the sensors is transmitted to a receiver located on the surface. There are a number of telemetry systems in the prior art which seek to transmit information regarding downhole parameters up to the surface without requiring the use of a wireline. These telemetry systems may not support an adequate data rate in the presence of noise.

### SUMMARY

In one embodiment of the present invention, a downhole telemetry system using discrete multitone modulation and adaptive filtering is provided The downhole telemetry system includes a downhole transmitter, a cable, and a surface receiver coupled to the downhole transmitter via the cable. The surface receiver adaptively filters noise from a signal received from the downhole transmitter.

In another embodiment of the present invention, a method of adaptively filtering communications with a downhole package using discrete multitone modulation is provided. The method includes receiving a time-domain signal carrying desired information at specific frequencies and adaptively filtering at least a portion of the noise from the time-domain signal. The time-domain signal includes noise.

In yet another embodiment of the present invention, a method of adaptively filtering periodic and non-periodic noise from communications with a downhole package using discrete multitone modulation is provided. The method includes receiving a time-domain signal carrying desired information at specific frequencies. The time-domain signal includes noise. The method also includes delaying the time-domain signal by a delay time to form a delayed time-domain signal, and adaptively filtering at least a portion of the periodic noise from the time-domain signal using the delayed time-domain signal. The method also includes receiving a reference signal from each of one or more sensors located to receive an indication of a component of the noise, and adaptively filtering at least a portion of each component of the noise from the time-domain signal using at least the reference signal from one of the one or more sensors.

### BRIEF DESCRIPTION OF THE DRAWINGS

For a detailed description of the preferred embodiments of the invention, reference will now be made to the accompanying drawings in which:

FIGS. 1A and 1B show a wireline sonde being run through a well, according to various embodiments of the present invention;

FIGS. 2A and 2B show cross-sections of seven-conductor wireline cables;

FIG. 3 shows a cross-section of a single-conductor logging cable;

FIG. 4 shows a cross-section of composite tubing with electrical conductors embedded in the wall;

FIG. 5 shows orthogonal mode transmission and receiving circuitry, according to one embodiment of the present invention;

FIG. 6 shows an embodiment of a discrete multi-tone transmitter, according to one embodiment of the present invention;

FIG. 7 shows an embodiment of a discrete multi-tone receiver, according to one embodiment of the present invention;

FIG. 8 shows an embodiment of a communications channel initialization method, according to one embodiment of the present invention;

FIG. 9 shows an embodiment of a system using an adaptive filter to remove periodic noise from a signal from a downhole telemetry system, according to one embodiment of the present invention;

FIG. 10 shows an embodiment of a system using an adaptive filter to remove non-periodic noise from a signal from the downhole telemetry system, according to one embodiment of the present invention; and

FIG. 11 shows a diagram of a system for removing periodic and non-periodic noise from the downhole telemetry system, according to one embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The terms upstream and downstream refer generally, in the context of this disclosure, to the transmission of information from subsurface equipment to surface equipment, and from surface equipment to subsurface equipment, respectively. Additionally, the terms surface and subsurface are relative terms. The fact that a particular piece of hardware is described as being on the surface does not necessarily mean it must be physically above the surface of the Earth; but rather, describes only the relative placement of the surface and subsurface pieces of equipment.

### DETAILED DESCRIPTION

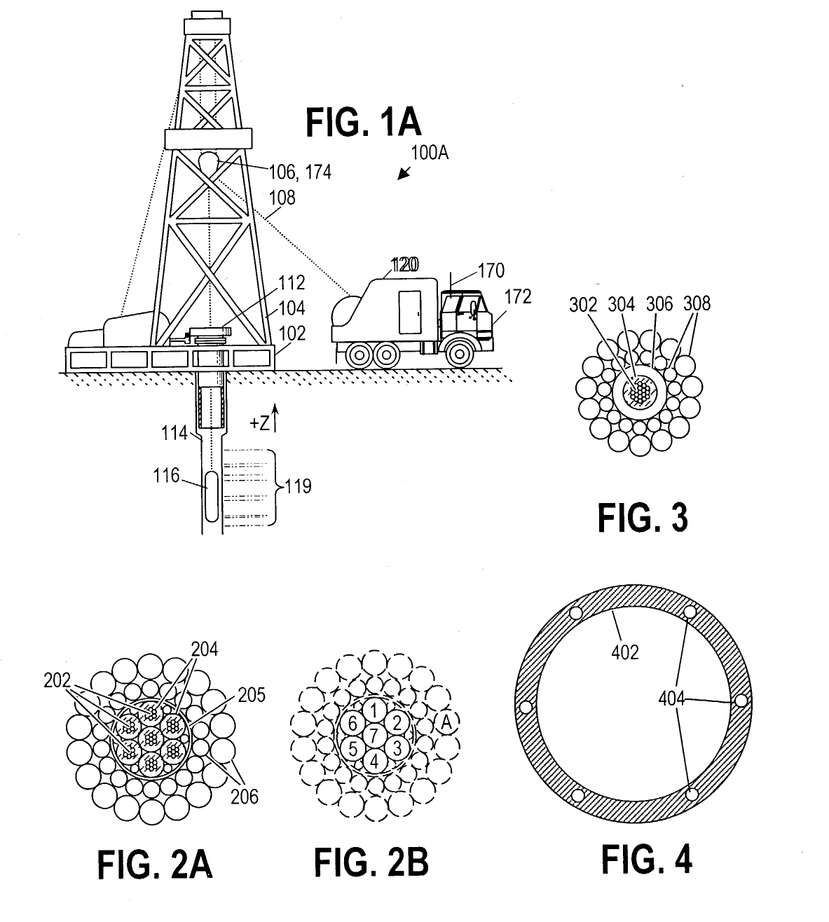

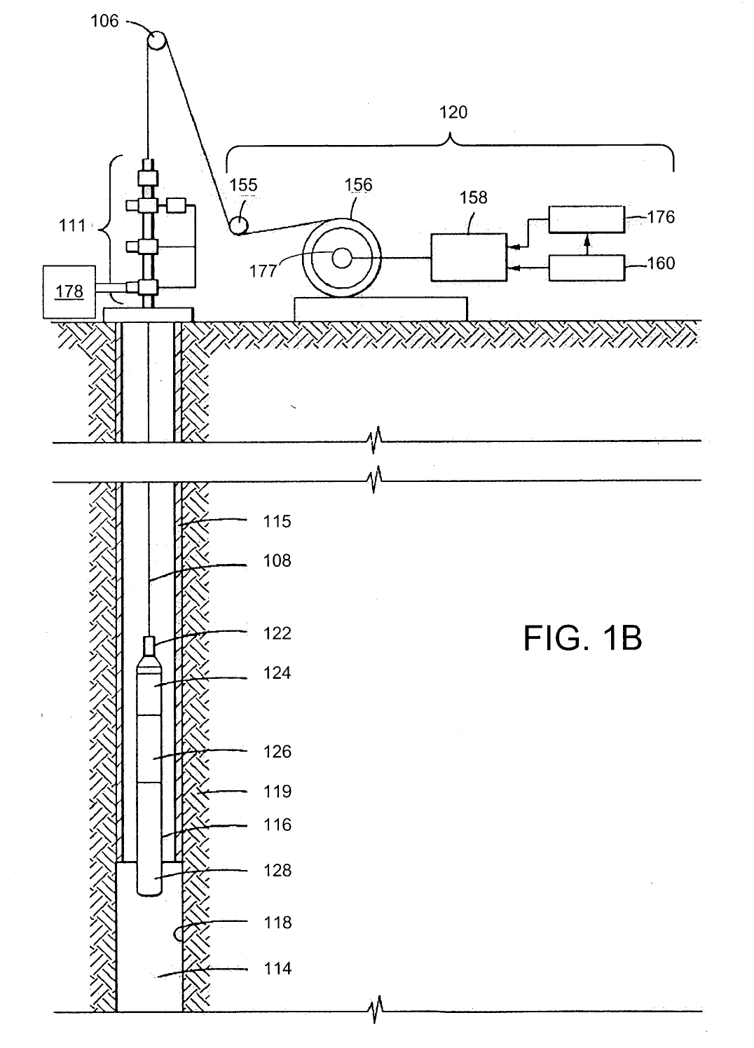

Turning now to the figures, FIG. 1A shows a well during wireline logging operations. A drilling platform 102 is equipped with an optional derrick 104 that supports a hoist 106, including a first sheave and a top drive 174. Drilling of oil and gas wells is commonly carried out by a string of drill pipes connected together by “tool” joints so as to form a drilling string that is lowered through a rotary table 112 into a wellbore 114. In FIG. 1, it is assumed that the drilling string has been temporarily removed from the wellbore 114 to allow a sonde 116 to be lowered by a wireline 108 into the wellbore 114. Typically, the sonde 116 is lowered to the bottom of the region of interest and subsequently pulled upward at a constant speed. During the upward trip, the sonde 116 performs measurements on the formations 119 adjacent to the wellbore 114 as the sonde 116 passes by.

The measurement data are communicated to a logging facility 120 for storage, processing, and analysis. The sonde and the logging facility 120 preferably employ telemetry transmitters and receivers using discrete multi-tone (DMT) modulation having adaptive noise cancellation. As shown, the logging facility 120 may be a mobile facility with an antenna 170 and air conditioning 172. As will be described in more detail below, the antenna 170, the air conditioner 172, the top drive 174, and other motors and power supplies may be sources of noise.

Referring to FIG. 1B, the well logging system 100B of the present invention may be seen as including the sonde 116, a well logging tool, lowered into a borehole 114 suspended on the cable 108. The borehole 114 may be cased with concentric casing 115 or be an open borehole such as at 118. The cable 108 extends from the tool 116 up through wellhead 111 and around the first sheave 106 and a second sheave 155 to a rotatable spool 156 for raising and lowering the cable 108 and the tool 116.

The conductors in cable 108 are typically connected to a transceiver 158. In an exemplary embodiment, the conductors in cable 108 are each connected to a corresponding electrically conductive slip ring (not shown) on the spool axle. The conductive slip rings transfer electrical currents from the cable that rotates with the spool to corresponding electrically conductive brushes “riding” on the slip rings. The brushes are then coupled to the transceiver 158. In this manner, signals are transferred from the rotating spool to the stationary transceiver 158 with negligible degradation.

The transceiver 158 receives the logging data and information and in turn transmits the data and information to a computer or microprocessor 160. The computer 160 analyzes the logging data received from the downhole tool 116 and typically displays the logging information for the operator. The computer 160 may be further configured to provide control signals to transceiver 158 for communication to well logging tool 116. The cable 108 is also connected via the transceiver 158 to a power supply 162 for supplying power to the logging tool 116. In a preferred embodiment, the power supply 162 is a programmable switching power supply configurable to produce adjustable voltages and waveforms under the control of computer 160. In well logging system 100B, the cable 108 is configured to safely deliver high electrical power and bi-directional telemetry to tool 116.

The well logging tool 116 may be any one of various types used for recording downhole data. It should be appreciated that the present invention is not limited to a particular well logging tool. Typically, the well logging tool 116 includes a cable head 122 with the upper portion of the tool 116 including suitable electronic circuitry for controlling the supply of power and the transmission of the signals to and from the tool 116. Typically the tool 116 includes a motorized unit 126 and an instrument package 128 for collecting the data on the surrounding formation 119.

In typical operation, the well logging tool 116 is passed downwardly through the cased borehole 115 and into the open borehole 118 and then retrieved from the borehole 114 by spooling the cable 108 onto the reel 156. As the well logging tool 116 passes through the borehole 114, information is gathered and collected on the characteristics on the formation 119 surrounding the borehole 114. The reel 156 is normally provided with a rotational electrical connector having stationary brushes for connecting to the transceiver 158.

In a preferred embodiment, cable 108 is a seven-conductor logging cable such as that which is obtainable from various companies including Camesa Inc., Cablesa, and the Rochester Corp. Suitable examples include the Rochester 7H464 15/32″ diameter cable or the Rochester 7H472 “SLAMMER” cable. Typical electrical characteristics of such cables are shown below.

| | |
|---|---|
| Electrical Insulation resistance | 1500 megohm/kft. |
| Rated insulation breakdown voltage | 1100 VDC (1200 VDC for 7H464) |
| Conductor series resistance | 10.5 ohms/kft. maximum |
| Capacitance (any conductor to | 40 to 50 pf/ft. (depends on |
| armor) | temp, rating and the |
| | insulating material) |
| Capacitive and series electrical | 4% maximum variation |
| resistance balance between outer | |
| 6 conductors | |

The geometry of these cables 108 is further described in FIGS. 2A, 2B, 3, and 4 and typically comprises two layers of contra-helically wound steel armor encasing seven electrical conductors. The geometry of the electrical conductors is six outer conductors wrapped around a seventh central conductor. The six outer conductors are equally spaced circumferentially. The steel armor is conductive (about 1 ohm/1000 ft), and is sometimes used as an eighth electrical conductor. The steel armor is also ferromagnetic, and may be magnetically “marked” at regular intervals as a way of monitoring the downhole position of the tool 116.

Other suitable examples of cable 108 include cables with stainless steel armor, MP35 armor, or other armors which have higher armor resistances. These cables may be preferred for corrosive drilling environments (e.g. high H₂S and/or CO₂ concentrations).

The cable 108 is typically five or more miles in length, and the electrical conductors are subject to strong capacitive and inductive coupling. As a consequence of this, signals sent downhole along any two arbitrary conductors are subject to distortion, and they produce significant “crosstalk” on the other conductors. One solution to this problem is to use separate cables for each signal, but this is expensive and not very reliable. Another solution to this problem is to use electrical “eigenmodes” in the cable for transmitting signals. By transmitting signals over groupings of conductors having certain symmetries, much of the coupling is cancelled out by the symmetry of the conductor grouping.

It is noted that the following telemetry system discussion will be presented primarily in the context of a wireline system. However, it is recognized that this telemetry system may also be used for MWD, and the claims are not limited to wireline systems.

FIG. 2A shows a cross-section of a typical wireline cable having multiple conductors 202. Each of the conductors 202 is surrounded by an insulating jacket 204. The insulated conductors 202 are bundled together in a semi-conductive wrap 205, which is surrounded by two layers of counter-wound metal armor wire 206. Being made of metal, the armor wires 206 are conductive and may be used as an eighth conductor. For the sake of convenience, FIG. 2B shows a cross-section of the same wireline cable having its conductors numbered 1-7 and its armor labeled A. This notation will be used in describing the use of transmission modes below. In wireline logging of cased and cemented wells, a single conductor logging cable such as that shown in FIG. 3 may be preferred. The single conductor cable typically has a single, multi-stranded conductor 302 encased in insulative material 304 and wound within a fabric liner 306 which is in turn wound within a double layer of counter wound metal armor wires 308. FIG. 4 shows a cross-section of yet another alternative: composite tubing 402 with embedded conductors 404. The conductors 404 are preferably equally spaced around the circumference of the tubing, and wound helically along its length.

Power and telemetry are typically conveyed together on a single cable. In single conductor cables, the power is generally transmitted as a low frequency signal, whereas the telemetry signal(s) are transmitted in a higher frequency band. In multi-conductor cables, the signal isolation is further improved by the use of orthogonal transmission modes.

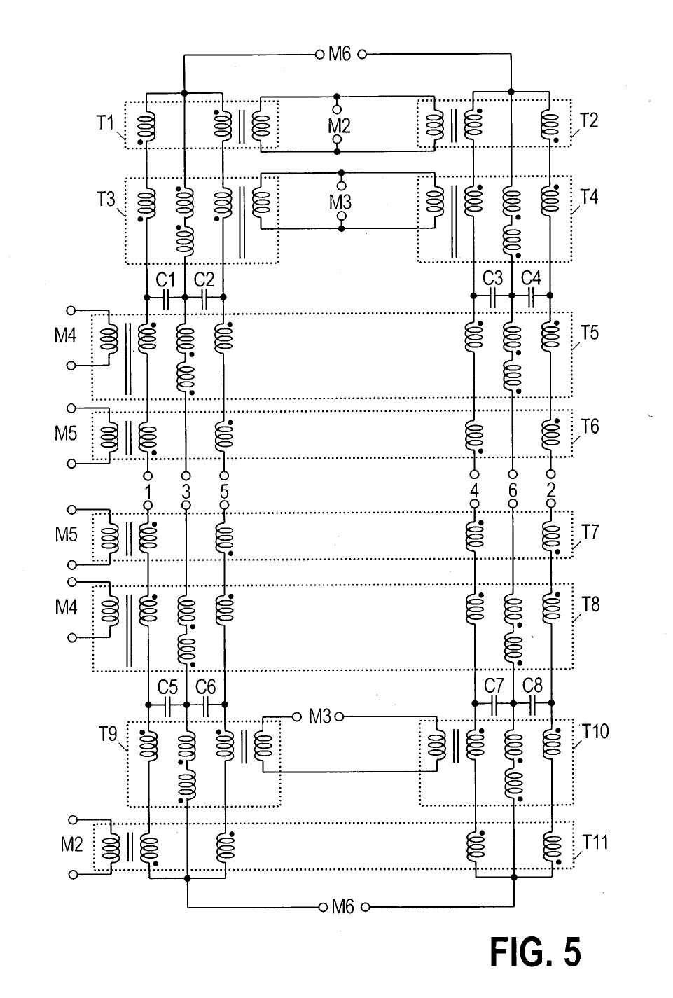

FIG. 5 shows one embodiment of telemetry circuitry that makes use of orthogonal transmission modes. The surface equipment includes mode transformers T1 through T6, and capacitors C1 through C4. The mode transformers induce voltages on conductors 1-6 of the multiconductor cable in response to voltages supplied to their primary windings. The combination and polarity of the voltages imposed on the conductors forms a transmission mode that is designed to be orthogonal to each of the other transmission modes. Signals carried via the different transmission modes can be independently received by similarly configured mode transformers T7-T11 in the downhole equipment. Similarly, signals may be transmitted uphole using the orthogonal modes by exciting the primaries of the appropriate downhole mode transformers, and the respective surface mode transformers can extract the mode signals without interference from signals carried in other modes. In short, the use of transmission modes eliminates signal cross-talk which would otherwise be caused by inductive and capacitive coupling between the conductors in the multi-conductor cable.

Power is supplied to terminals M6 for transport downhole via mode M6. To activate mode M6, conductors 1, 3, and 5 are placed at one polarity while the three remaining conductors 2, 4, and 6, must be placed at the opposite polarity. Since this is done by direct connection in FIG. 5 as opposed to transformer coupling, the mode M6 voltage may be either AC or DC. The power provided to mode M6 at the surface may preferably be as high as 1300 volts at 3 amps.

Power may also be supplied to terminals M2 for transport downhole. Mode M2 power is excited on conductors 1-6 by driving conductors 1 and 2 with one polarity while driving conductors 4 and 5 with the opposite polarity. Power transmitted via this modes may preferably be limited to less than 240 watts, with 120 watts delivered to the load at the opposite end of the cable.

Power supplied to terminals M3 is impressed by transformer T3 as a potential between conductor 3 and conductors 1 and 5, and by transformer T4 as an equal but opposite potential between conductor 6 and conductors 2 and 4. This excites mode M3 in the cable.

Transformers T1-T4 are power transformers which may have windings with a significant series inductance. This series inductance may effectively form an open circuit to signals transmitters at typical telemetry frequencies. To counteract this effect, the circuit of FIG. 5 has capacitors C1 through C4 to provide closed current paths at typical telemetry frequencies.

Mode transformer T5 operates to transmit and receive telemetry signals. Signals provided to terminals M4 are impressed as a potential between conductor 3 and conductors 1 and 5, and as an equal potential between conductor 6 and conductors 2 and 4. This excites mode M4 in the cable. The voltages at terminals M4 also reflect mode M4 signals received from downhole by mode transformer T8.

Mode transformer T6 similarly operates to transmit and receive telemetry signals. Signals provided to terminals M5 are impressed by driving conductors 1 and 4 with one polarity while driving conductors 2 and 5 with the opposite polarity. This excites mode M5 in the cable. The voltages at terminals M5 also reflect mode M5 signals transmitted from downhole by mode transformer T7.

In the downhole equipment, mode transformers T7 and T8, with the help of capacitors C5-C8, operate similarly to mode transformers T5 and T6 to send and receive telemetry signals via modes M5 and M4, respectively. Transformers T9 and T10 receive mode M3 power and provide it at terminals M3. Transformer T11 receives mode M2 power and provides it to the terminals marked M2. Mode M6 power is available at terminals M6.

Eigenmode transmission in multiconductor cables is treated by David F. Strawe in the Boeing Co. report number D2-19734-1 “Analysis of Uniform Symmetric Transmission Lines” Jan. 27, 1971, and in Boeing Co. report number D2-26245-1 “Analysis of the controlled-Lay Cable” January 1973. Additional information can be found in “Multiconductor Transmission Line Analysis”, by Sidnely Frankel, Artech House Inc., 1977, “Analysis of Multiconductor Transmission Lines (Wiley Series in Microwave and Optical Engineering), Clayton R. Paul, 1994, and in U.S. Pat. No. 3,603,923 dated Sep. 10, 1968 by Nulligan describing equipment using eigenmode transmission on a multiconductor cable. Orthogonal modes and the circuit of FIG. 5 are discussed in much greater detail in co-pending application Ser. No. 09/437,594, entitled “High-Power Well Logging Method And Apparatus” by inventors G. Baird, C. Dodge, T. Henderson and F. Velasquez. These references are hereby incorporated by reference.

Accordingly, there are at least two methods for establishing a communications channel for downhole communications. One of several orthogonal transmission modes may be used to carry the telemetry signal on a multiconductor cable, or a single conductor cable may be used to carry the telemetry signal in the normal fashion. In any case, it is desirable to maximize the rate at which information may be conveyed across the communications channel in the presence of noise.

Information is typically conveyed by modulation of a carrier signal. One modulation technique which may be preferred for this application is discrete multi-tone (DMT) modulation. DMT modulation is used in Asymmetrical Digital Subscriber Line (ADSL) systems. ADSL systems commonly communicate via “twisted wire pair” cables. The available bandwidth for a long twisted pair cable extends in frequency to approximately 1.1 MHz. DMT modulation effectively divides the available bandwidth of the system into sub-channels 4.3125 kHz wide, giving 256 possible sub-channels in the 1.1 MHz bandwidth. Traditional ADSL reserves the first sub-channel (from 0-4 kHz) for audio telephone signals, and typically provides a guard band separating the sub-channels for communication from the traditional telephone service band.

In the ideal case, each frequency sub-channel, or bin, would have the same data transmission rate as all the other frequency sub-channels. However, the data rate for each sub-channel varies for a myriad of reasons. For example, interference having a particular frequency may affect certain sub-channels whose frequency is at or near the frequency of the noise source. In this instance, those sub-channels with frequencies about the same as the noise source have lower signal to noise ratios and therefore their data carrying capacity is lower than other channels. In addition to interference from outside sources, the twisted pair cable itself may have an affect on the data carrying capacity of each sub-channel. Resistive and capacitive effects in the cable cause a frequency-dependent attenuation of the signals passing therethrough. The cable attenuation generally varies smoothly as a function of frequency with increasing attenuation at higher frequencies. Other system components, such as transformers or suboptimal impedance matching connectors, may further aggravate attenuation at selected frequencies. To compensate for line impairments of a twisted pair cable, a preferred embodiment measures the data transmission capability of each sub-channel and assigns a data transmission rate for that sub-channel to insure that each channel is used at its maximum reliable data transmission rate given its signal to noise ratio.

For downhole communication systems, the sub-channels are preferably divided into an upstream band and a downstream band. The usable bandwidth between 0 and 1.1 MHz is preferably divided into 256 equally spaced subchannels each 4.3125 kHz wide. Some of the subchannels may be reserved for dedicated purposes. For example, assuming that the subchannels are numbered in order from low frequency to high frequency, subchannel #84 may be reserved for a pilot signal. A lower subchannel #1 may be unused to provide a guard band for power signals. Some applications may call for 4 kHz power and allowance for harmonics may be desired.

It is noted that the uplink and downlink information transfer rate requirements are generally not static as is assumed in most communication systems designs. During initialization and configuration of downhole instruments, it is desirable to provide a downlink information transfer capacity that is substantially larger than the uplink information transfer capacity. The downlink is used to transfer software, commands, and parameters, and the role of the uplink is generally limited to acknowledging receipt of information packets. During normal operation, the downlink is generally limited to acknowledgements, while the uplink carries measurement data and status information. Other channel definitions and divisions are also contemplated for use with various embodiments of the present invention.

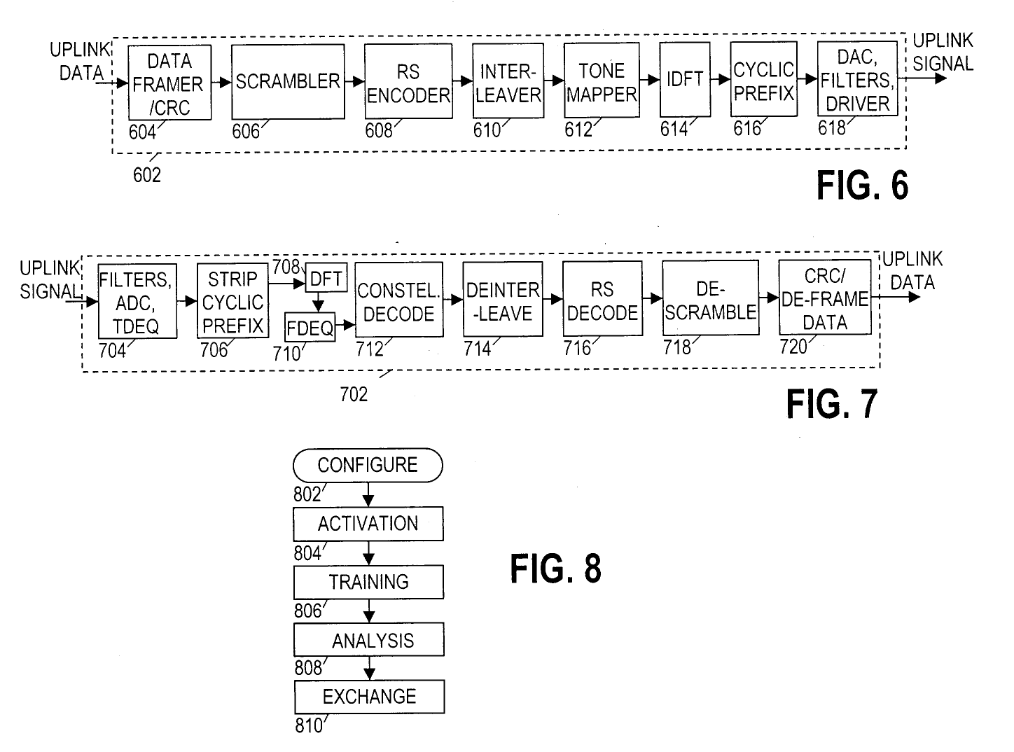

FIG. 6 shows a block diagram of a DMT transmitter 602. It includes a data framer 604, a scrambler 606, an encoder 608, an interleaver 610, a tone mapper 612, an inverse discrete Fourier transform (IDFT) block 614, a cyclic prefix generator 616, and a line interface 618. The data framer 604 groups bytes of uplink data together to form data frames. The data frames are then grouped together with a synchronization frame and a cyclic redundancy checksum (CRC) which is calculated from the contents of the data frames. The CRC provides one means for detecting errors in data received at the receiving end. The scrambler 606 combines the output of the data framer 604 with a pseudo-random mask. This “randomizes” the data so as to flatten the frequency spectrum of the data signal. The scrambled data is encoded by the encoder 608 with an error correction code that adds redundancy to the data stream. The redundancy may be used to detect and correct errors caused by channel interference. A Reed-Solomon (RS) code is preferred, but other error correction codes may also be used.

The interleaver 610 is preferably a convolutional interleaver which reorders data stream symbols so as to “spread out” previously adjacent symbols. This prevents an error burst from overcoming the localized error correction ability of the error correction code. The tone mapper 612 takes bits from the data stream and assigns them to frequency bins. For each frequency bin, the bits are used to determine a discrete Fourier transform (DFT) coefficient that specifies a frequency amplitude. The number of bits assigned to each frequency bin is variable (i.e. may be different for each bin) and dynamic (i.e. may change over time), and depends on the estimated error rate for each frequency. Microcontrollers (not shown) at each end and/or the computer 160 cooperate to determine the error rate detected by the receiver in each frequency band, and to adjust the tone mapper accordingly. The coefficients provided by the tone mapper 612 are processed by the IDFT block 614 to generate a time-domain signal carrying the desired information at each frequency in the form of a DMT symbol.

The cyclic prefix block 616 duplicates the end portion of the time-domain signal and prepends it to the beginning of the time domain signal. This permits frequency domain equalization of the signal at the receiving end. The prefixed signal is then converted into analog form, filtered, and amplified for transmission across the communications channel by line interface 618.

A block diagram of a DMT receiver 702 is shown in FIG. 7. It includes a line interface 704, a cyclic prefix stripper 706, a DFT block 708, a frequency domain equalizer 710, a constellation decoder 712, a de-interleaver 714, an error correction decoder 716, a descrambler 718, and a de-framer 720. The line interface 704 filters the received signal, converts it to digital form, and performs any desired time domain equalization. The time domain equalization at least partially compensates for distortion introduced by the channel, but it is likely that at least some intersymbol interference will remain.

The cyclic prefix stripper 706 removes the cyclic prefixes that were added by the cyclic prefix block 616, but importantly, trailing intersymbol interference from the cyclic prefix remains in the signal. If desired, frequency domain equalization may be performed by block 710 to compensate for any remaining intersymbol interference. It is noted that frequency domain equalization on DFT coefficients is a cyclic convolution operation which would lead to incorrect equalization results had the cyclic prefix not been transmitted across the channel.

The constellation decoder 712 extracts the data bits from the frequency coefficients using an inverse mapping of the tone mapper 712. The de-interleaver 714 then returns the data stream to its original order. The decoder 716 decodes the data stream correcting such errors as are within its correcting ability, and descrambler 718 combines the data with the pseudo-random mask to return the data to its unscrambled form. The de-framer 720 then identifies and removes synchronization information, and determines if the CRC indicates the presence of any errors. If error free, the data is forwarded to the output. Otherwise, the microcontroller is notified of errors in the data.

Taken together, FIGS. 6 and 7 show how uplink telemetry can be conveyed across a communications channel according to various embodiments of the present invention. Downlink communications can be similarly conveyed. The components may be implemented as discrete hardware, or preferably may be implemented as software of a digital processor within the modem. Other software and hardware implementations are also contemplated.

FIG. 8 shows one method of configuring the communications channel. The surface transceiver executes a configuration routine 802 that begins with an activation block 804. In this block, the modems are both powered on, and a handshake phase is performed. The modems each transmit single tones to identify themselves and determine which one will control the timing of the channel. The activation block is followed by a training block 806 in which each modem takes turns transmitting wideband signals. The wideband signals allow each unit to calculate the received power spectral density, to adjust automatic gain controls, and to perform initial training of the equalizers in each receiver. The training block is followed by an analysis block 808. In the analysis block, the two modems communicate capabilities and configuration information to each other. This information preferably includes desired information transmission rates. In the exchange block 810, the modems negotiate a mutually acceptable configuration.

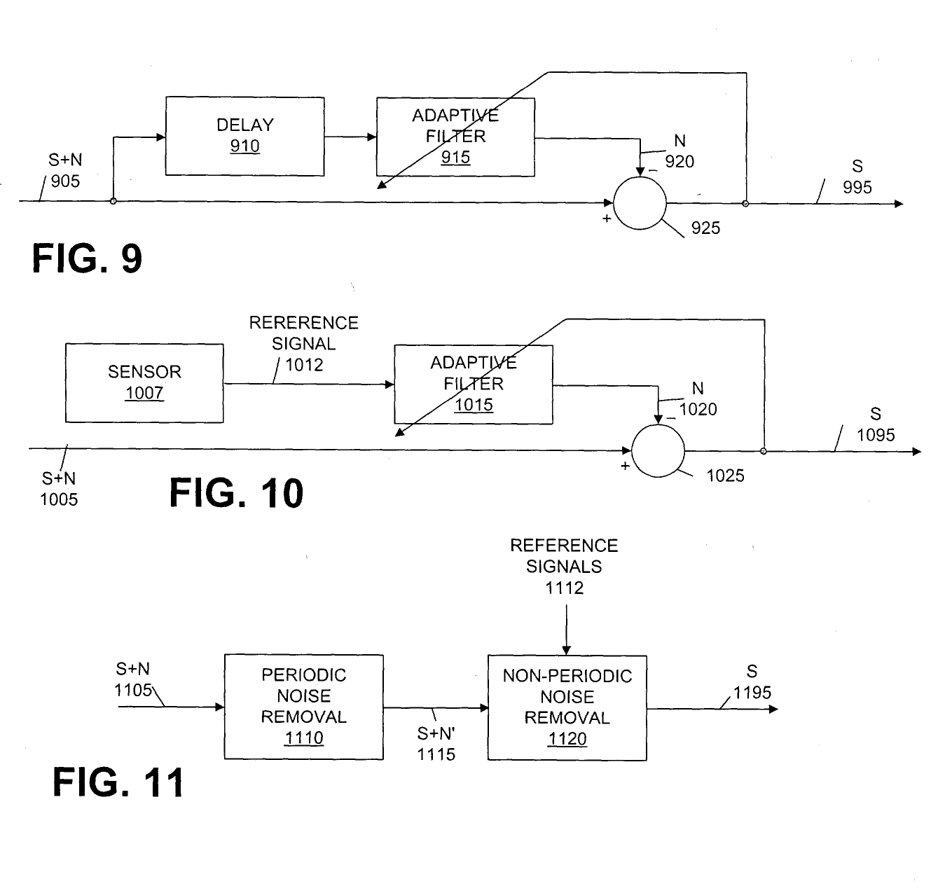

FIG. 9 shows an embodiment of a system using an adaptive filter 915 to remove periodic noise from a signal 905 from a downhole telemetry system. As shown, the embodiment of the system includes the signal 905, including periodic noise, provided to a delay element 910 and to a summing junction 925. The delayed signal output from the delay element 910 is provided to the adaptive filter 915. The adaptive filter 915 operates on the delayed signal to estimate a periodic noise signal 920 which is then subtracted from signal 905 by summing junction 925 to provide a signal 995 with the periodic noise substantially removed. An adaptation algorithm is applied to adaptive filter 915 to minimize the periodic noise signal component in signal 995. Many suitable adaptation techniques may be found in standard textbooks, see e.g., Simon Haykin's Adaptive Filter Theory, Prentice Hall, Englewood Cliffs, 1986.

Note that exemplary sources of periodic noise are included in the wireline logging operations shown in FIGS. 1A and 1B. These exemplary sources include motors and power supplies, such as the air conditioner 172, the top drive 174, the power supply 176, the winch motor 177, and the mud pump 178. These motors and power supplies may operate at various frequencies and generate one or more harmonics that may cause periodic noise. While specific examples are given for producing periodic noise, other sources of noise may be found by examination of a particular well logging site, the examination being within the abilities of one of ordinary skill in the art having the benefit of this disclosure. The choice of delay times for the delay element 910 may be constants based on known frequencies or harmonics. The delay times may also be variable within a predetermined range based on expected frequencies or harmonics.

FIG. 10 shows an embodiment of a system using an adaptive filter 1015 to remove non-periodic noise from a signal 1005 from the downhole telemetry system. As shown, the embodiment of the system includes the signal 1005, including non-periodic noise provided to a summing junction 1025. A sensor 1007 provides a reference signal 1012 to the adaptive filter 915, which operates on the reference signal to estimate the non-periodic noise present in the signal 1005. As part of the adaptation process, the adaptive filter 1015 also receives a signal 1095 with the non-periodic noise substantially removed. The adaptive filter 1015 provides an estimate of the non-periodic noise signal 1020 to the summing junction 1025. The summing junction 1025 outputs the signal 1095.

Note that exemplary sources of non-periodic noise are included in the wireline logging operations shown in FIGS. 1A and 1B. These exemplary sources include motors and power supplies, such as the air conditioner 172, the top drive 174, the power supply 176, the winch motor 177, and the mud pump 178, as well as radio interference (detectable via antenna 170 ). Machinery may also cause vibrations sufficient to induce noise in the well logging signals. While specific examples are given for producing non-periodic noise, other sources of noise may be found by examination of a particular well logging site, the examination being within the abilities of one of ordinary skill in the art having the benefit of this disclosure.

The reference signal 1012 may be generated by the sensor 1007 placed near the source whose non-periodic noise is to removed from the signal 1005. The sensor 1007 may be chosen by one of ordinary skill in the art having the benefit of this disclosure based on the implementation desired. Exemplary sensors include current and voltage sensors coupled to power supplies of electrically driven equipment or other points of interest (e.g. the well head, an engine block), and antennas for detecting electromagnetic interference.

FIG. 11 shows a diagram of a system for removing periodic and non-periodic noise from the downhole telemetry system, according to one embodiment of the present invention. As shown, the embodiment of the system includes a signal 1105 including one or more of periodic and/or non-periodic noise processed to remove first periodic noise 1110 and then non-periodic noise 1120 to form an estimate of the signal 1195. The result of the removal of the periodic noise 1110 is the signal with modified noise 1115. One or more reference signals 1212 are provided to the non-periodic noise removal 1120. Note that the periodic noise removal 1110 may be performed using to the system shown in FIG. 9, and the non-periodic noise removal 1120 may be performed using to the system shown in FIG. 10.

The adaptive filters 915 and 1015 are within the abilities of one of ordinary skill in the art having the benefit of this disclosure. General references for adaptive filters include (1) Simon Haykin's Adaptive Filter Theory, Prentice Hall, Englewood Cliffs, ©1986, and (2) B. Farhang-Boroujeny's Adaptive Filters Theory and Applications, John Wiley & Sons, ©2000, each incorporated by reference herein in their entireties.

A software implementation of the embodiments described above may comprise a series of computer instructions either fixed on a tangible medium, such as a computer readable media, e.g. a diskette, a CD-ROM, a ROM, or fixed disk, or transmittable to a computer system, via a modem or other interface device, such as a communications adapter connected to the network over a transmission medium. The medium can be either a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect a given embodiment of the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

The above discussion is meant to be illustrative of the principles and various embodiments of the present invention. For example, the present invention has been discussed in the context of wireline logging. However, it may also prove advantageous in the context of LWD, particularly in when composite tubing is used. Numerous variations and modifications will become apparent to those skilled in the art once the above disclosure is fully appreciated. It is intended that the following claims be interpreted to embrace all such variations and modifications.

What is claimed is:

1. A downhole telemetry system using discrete multitone modulation and adaptive filtering, wherein the downhole telemetry system comprises:
a downhole transmitter;
a cable; and
a surface receiver coupled to the downhole transmitter via the cable, wherein the surface receiver adaptively filters noise from a signal received from the downhole transmitter.

2. The downhole telemetry system of claim 1 wherein the noise includes periodic noise.

3. The downhole telemetry system of claim 2 wherein the noise further includes non-periodic noise.

4. The downhole telemetry system of claim 3, wherein the downhole telemetry system further comprises:
one or more sensors positioned to receive an indication of the non-periodic noise.

5. The downhole telemetry system of claim 4, wherein the downhole telemetry system further comprises:
a noise source generating the noise.

6. The downhole telemetry system of claim 5 wherein the noise source includes a motor.

7. The downhole telemetry system of claim 5 wherein the noise source includes a power supply.

8. The downhole telemetry system of claim 5 wherein the noise source includes an antenna.

9. The downhole telemetry system of claim 2 wherein surface receiver includes a delay element configured to correspond approximately to a period of a first noise frequency.

10. The downhole telemetry system of claim 9, wherein the downhole telemetry system further comprises:
a noise source generating the noise.

11. The downhole telemetry system of claim 10 wherein the noise source includes a motor.

12. The downhole telemetry system of claim 10 wherein the noise source includes a power supply.

13. The downhole telemetry system of claim 10 wherein the noise source includes an antenna.

14. The downhole telemetry system of claim 1 wherein the noise includes non-periodic noise.

15. The downhole telemetry system of claim 14, wherein the downhole telemetry system further comprises:
one or more sensors positioned to receive an indication of the non-periodic noise.

16. The downhole telemetry system of claim 15, wherein the downhole telemetry system further comprises:
a noise source generating the noise.

17. The downhole telemetry system of claim 16 wherein the noise source includes a motor.

18. The downhole telemetry system of claim 16 wherein the noise source includes a power supply.

19. The downhole telemetry system of claim 16 wherein the noise source includes an antenna.

20. The downhole telemetry system of claim 1 that further comprises:
a surface transmitter; and
a downhole receiver coupled to the surface transmitter via the cable.

21. The downhole telemetry system of claim 20, wherein a surface transceiver comprises the surface transmitter and the surface receiver, and wherein a downhole transceiver comprises the downhole transmitter and the downhole receiver.

22. A method of adaptively filtering communications with a downhole package using discrete multitone modulation, wherein the method comprises:
receiving a time-domain signal carrying desired information at specific frequencies, wherein the time-domain signal includes noise; and
adaptively filtering at least a portion of the noise from the time-domain signal.

23. The method of claim 22, wherein the method further comprises:
receiving a reference signal from a sensor located to receive an indication of the noise; and
wherein adaptively filtering at least the portion of the noise from the time-domain signal comprises adaptively filtering at least the portion of the noise from the time-domain signal using the reference signal.

24. The method of claim 23, wherein the method further comprises:
delaying the time-domain signal by a delay time to form a delayed time-domain signal; and
wherein the noise includes periodic noise, and wherein adaptively filtering at least the portion of the noise from the time-domain signal comprises adaptively filtering at least a portion of the periodic noise from the time-domain signal using the delayed time-domain signal.

25. The method of claim 22, wherein the method further comprises:
delaying the time-domain signal by a delay time to form a delayed time-domain signal; and
wherein the noise includes periodic noise, and wherein adaptively filtering at least the portion of the noise from the time-domain signal comprises adaptively filtering at least a portion of the periodic noise from the time-domain signal using the delayed time-domain signal.

26. A method of adaptively filtering periodic and non-periodic noise from communications with a downhole package using discrete multitone modulation, wherein the method comprises:
receiving a time-domain signal carrying desired information at specific frequencies,
wherein the time-domain signal includes noise;
delaying the time-domain signal by a delay time to form a delayed time-domain signal;
adaptively filtering at least a portion of the periodic noise from the time-domain signal using the delayed time-domain signal;
receiving a reference signal from each of one or more sensors located to receive an indication of a component of the noise; and
adaptively filtering at least a portion of each component of the noise from the time-domain signal using at least the reference signal from one of the one or more sensors.
